(19) United States
(12) Patent Application Publication
(10) Pub. No.: US 2019/0345758 A1
(43) Pub. Date: Nov. 14, 2019

(54) RESIDENTIAL PACKAGE DELIVERY DOOR SYSTEM

(71) Applicant: Denis Matthew Drost, Etobicoke (CA)

(72) Inventor: Denis Matthew Drost, Etobicoke (CA)

(21) Appl. No.: 15/976,264

(22) Filed: May 10, 2018

(51) Int. Cl. E06B 7/32; E06B 5/02; E06B 7/16

(52) U.S. Cl. CPC E06B 7/32; E06B 7/16; E06B 5/025

(57) ABSTRACT

A residential package delivery door system including a package receiving apparatus including a front plate, a back plate, a panel, a locking mechanism, and a video system. The package receiving apparatus is in communication with an application hosted on a mobile device. A user is able to view a live video stream captured by the video system on a display of the mobile device. The user is able to lock and unlock the locking mechanism of the package receiving apparatus from the mobile device. The package receiving apparatus includes an opening and is mounted to a host door, the package receiving apparatus is configured to securely receive packages therethrough and effectively prevent theft of the packages.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of doors and more specifically relates to a delivery door.

### 2. DESCRIPTION OF RELATED ART

People when not home or in the office have difficulty in having parcels delivered or collected in a safe and secure way without granting the delivery or collection person access into the property. Packages left outside can be easily stolen. This is undesirable. With the rise in convenience services such as online shopping and home collection and return of laundry and dry-cleaning and the like, a solution is needed for such deliveries and collections to occur safely without anyone being present at the property to grant access.

U.S. Pat. No. 9,619,955 to David L. Eichenblatt relates to a systems and methods for facilitating package delivery or pickup. The described systems and methods for facilitating package delivery or pickup includes a system for facilitating package delivery or pickup at premises of senders or recipients has a package door that is used for receipt and collection of packages. The package door includes an input device for entering package information and an image capture device for visually recording the arrival of a courier. Based on the package information entered via the input device, the system determines whether the package information matches a predetermined value, such as a package tracking number. The system may automatically unlock the package door if the package information matches such predetermined value. In other embodiments, a user may remotely monitor the package information and/or information from the image capture device to determine whether to provide inputs for unlocking the package door. The system logs the package information received from the input device and the image capture device.

### BRIEF SUMMARY OF THE INVENTION

In view of the foregoing disadvantages inherent in the known doors art, the present disclosure provides a novel residential package delivery door system. The general purpose of the present disclosure, which will be described subsequently in greater detail, is to provide a package receiving door for accepting packages remotely and securing packages within a home to prevent theft of packages.

A residential package delivery door system is disclosed herein. The residential package delivery door system includes a package receiving apparatus having a front plate, a back plate, a panel, a locking mechanism, and a video system. The package receiving apparatus is in communication with an application hosted on a mobile device. A user is able to view a live video stream captured by the video system on a display of the mobile device. The user is able to lock and unlock the locking mechanism of the package receiving apparatus from the mobile device. The package receiving apparatus includes an opening and is mounted to a host door, the package receiving apparatus is configured to securely receive packages therethrough and effectively prevent theft of the packages. The front plate is configured to be mounted to a front-side of the host door and the back plate is configured to be mounted to a back-side of the host door. The engagement with the video doorbell is not started via a bar-code scan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a residential package delivery door system, constructed and operative according to the teachings of the present disclosure.

FIG. 1 is a perspective view of the residential package delivery door system during an ‘in-use’ condition, according to an embodiment of the disclosure.

FIG. 2 is a perspective view of the residential package delivery door system of FIG. 1, according to an embodiment of the present disclosure.

FIG. 3 is a perspective view of the residential package delivery door system of FIG. 1 configured on a garage door, according to an embodiment of the present disclosure.

FIG. 4 is a perspective view of the residential package delivery door system of FIG. 1, according to an embodiment of the present disclosure.

FIG. 5 is a perspective view of the residential package delivery door system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to doors and more particularly to a residential package delivery door system as used to improve the delivery of packages in residential home areas.

Generally, the invention provides means to receive and to secure a package in a residential home through a delivery door. This may be accessed via a mobile app to unlock the delivery door while the package is being delivered. The door includes a video engaged receiving door for residential front doors or garage doors. This receiving door will allow users to watch a delivery happen using preexisting devices. The device may be activated by a doorbell ring (not by a bar-code scan). Once the doorbell is engaged a user is able to see that a package is being delivered and unlock the delivery door and allow the delivery person to place the box through the door chute. Once the item is placed through the delivery chute and the door has closed a user is be notified on a device that door is closed and locked. The user can watch the delivery person leave via the video system. This will eliminate theft of items left on front door steps and reduce multiple visits by delivery services and customers to other locations because delivery of expensive items could not be dropped off.

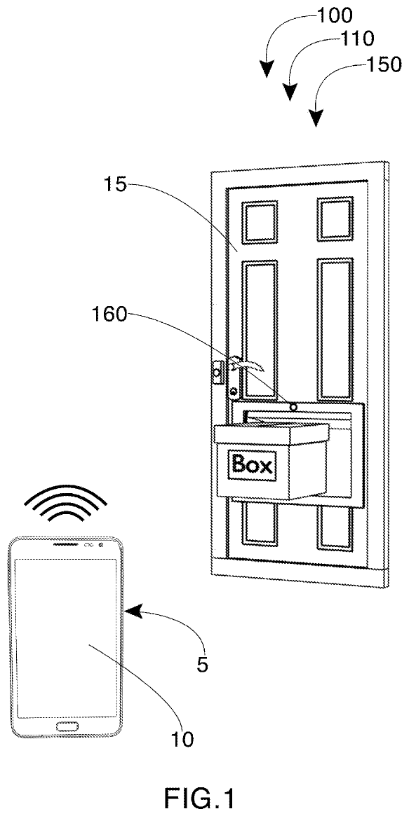

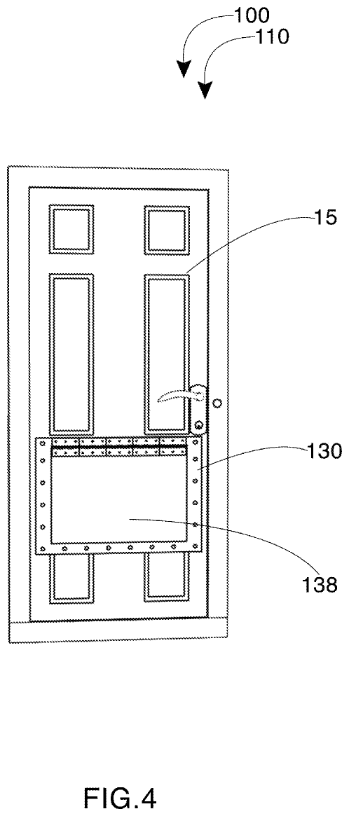

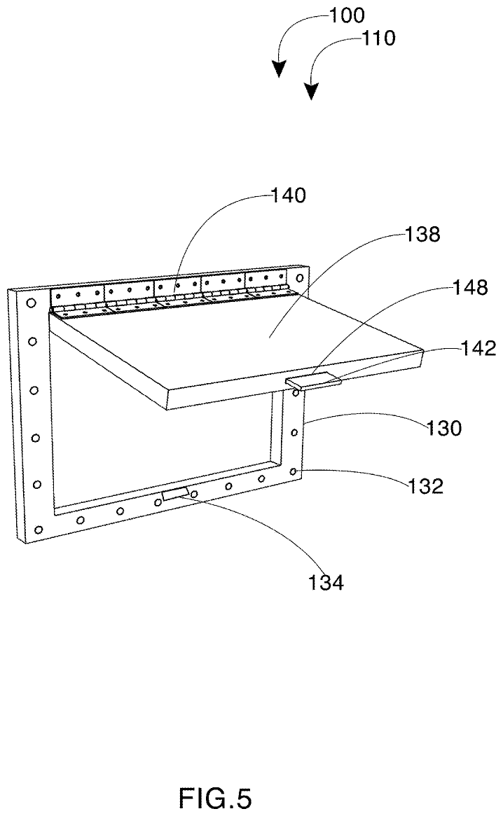

Referring now more specifically to the drawings by numerals of reference, there is shown in FIGS. 1-5, various views of a residential package delivery door system 100. FIG. 1 shows a residential package delivery door system 100 during an ‘in-use’ condition 150, according to an embodiment of the present disclosure. As illustrated, the residential package delivery door system 100 may include a package receiving apparatus 110 having a front plate 120, a back plate 130, a panel 138, a locking mechanism 148, and a video system 160. The package receiving apparatus 110 is in communication with an application hosted on a mobile device 5. The package receiving apparatus 110 may include a wireless transmitter. A user is able to view a live video stream captured by the video system 160 on a display 10 of the mobile device 5. The user is able to lock and unlock the locking mechanism 148 of the package receiving apparatus 110 from the mobile device 5. The package receiving apparatus 110 includes an opening and is mounted to a host door 15. The package receiving apparatus 110 is configured to securely receive packages therethrough and effectively prevent theft of the packages.

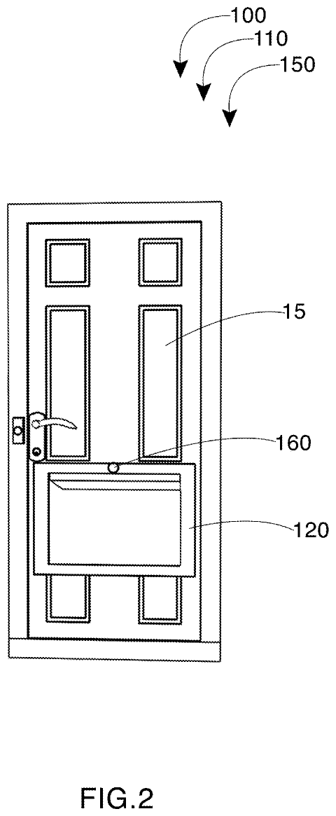

FIGS. 2-5 show various views of the residential package delivery door system 100 of FIG. 1, according to an embodiment of the present disclosure. As above, the residential package delivery door system 100 may include the package receiving apparatus 110 including the front plate 120, the back plate 130, the panel 138, the locking mechanism 148, and the video system 160. The package receiving apparatus 110 further includes a wifi transmitter in communication with the mobile device 5. The package receiving apparatus 110 is configured to send a notification to the mobile device 5 when the package is delivered and the locking mechanism 148 is locked. Bar-code scanning does not allow the present invention to be opened.

The front plate 120 is configured to be mounted to a front-side of the host door 15. The back plate 130 and the panel 138 are configured to be mounted to a back-side of the host door 15. The video system 160 is activated when a doorbell is rung. The back plate 130 comprises a plurality of screw apertures 132. The screw apertures 132 are positioned along an outer perimeter of the back plate 130. The back plate 130 further comprises a lock hole 134. The front plate 120 includes a rigid plastic covering. The front plate 120 and the back plate 130 comprise a substantially similar profile, preferably a rectangular-profile. The front plate 120 and the back plate 130 are large enough to receive a plurality of different sized packages. The panel 138 is also rectangular shaped and includes a hinged fastener 140. The hinged fastener 140 is positioned on a top edge of the panel 138 and secures the panel 138 to the back plate 130. The panel 138 further comprises a door lock 142 opposing the hinged fastener 140.

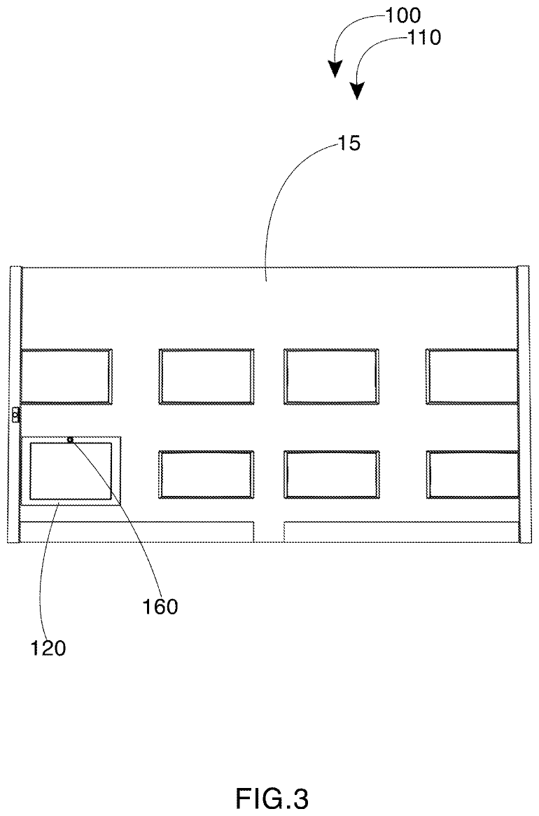

The package receiving apparatus 110 includes the opening connected to a door-chute. The device is mounted to the host door 15 and is configured to securely receive packages therethrough and effectively prevent theft of the packages. In one embodiment, the host door 15 may be a residential front-door. As shown in FIG. 3, the host door may also be a garage-door.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A residential package delivery door system comprising:
a package receiving apparatus including;
a front plate;
a back plate;
a panel;
a locking mechanism; and
a video system;
wherein said package receiving apparatus is in communication with an application hosted on a mobile device;
wherein a user is able to view a live video stream captured by said video system on a display of said mobile device;
wherein said user is able to lock and unlock said locking mechanism of said package receiving apparatus from said mobile device; and
wherein said package receiving apparatus includes an opening and is mounted to a host door, said package receiving apparatus is configured to securely receive packages therethrough and effectively prevent theft of said packages.

2. The residential package delivery door system of claim 1, wherein said front plate is configured to be mounted to a front-side of said host door.

3. The residential package delivery door system of claim 2, wherein said back plate is configured to be mounted to a back-side of said host door.

4. The residential package delivery door system of claim 1, wherein said video system is activated when a doorbell is rung.

5. The residential package delivery door system of claim 1, wherein said package receiving apparatus is configured to send a notification to said mobile device when said package is delivered and said locking mechanism is locked.

6. The residential package delivery door system of claim 1, wherein said back plate comprises a plurality of screw apertures.

7. The residential package delivery door system of claim 6, wherein said screw apertures are positioned along an outer perimeter of said back plate.

8. The residential package delivery door system of claim 1, wherein said back plate further comprises a lock hole.

9. The residential package delivery door system of claim 1, wherein said front plate includes a rigid plastic covering.

10. The residential package delivery door system of claim 1, wherein said front plate and said back plate comprise a substantially similar profile.

11. The residential package delivery door system of claim 10, wherein said front plate and said back plate comprise a rectangular-profile.

12. The residential package delivery door system of claim 12, wherein said panel is rectangular shaped.

13. The residential package delivery door system of claim 1, wherein said panel includes a hinged fastener.

14. The residential package delivery door system of claim 13, wherein said hinged fastener is positioned on a top edge of said panel.

15. The residential package delivery door system of claim 14, wherein said panel further comprises a door lock opposing said hinged fastener.

16. The residential package delivery door system of claim 1, wherein said host door is a residential front-door.

17. The residential package delivery door system of claim 1, wherein said host door is a garage-door.

18. The residential package delivery door system of claim 1, wherein said opening comprises a door-chute.

19. A residential package delivery door system, the residential package delivery door system comprising:
a package receiving apparatus including;
a front plate;
a back plate;
a panel;
a locking mechanism; and
a video system;
wherein said package receiving apparatus is in communication with an application hosted on a mobile device;
wherein a user is able to view a live video stream captured by said video system on a display of said mobile device;
wherein said video system is activated when a doorbell is rung;
wherein said user is able to lock and unlock said locking mechanism of said package receiving apparatus from said mobile device;
wherein said package receiving apparatus includes an opening and is mounted to a host door, said package receiving apparatus is configured to securely receive packages therethrough and effectively prevent theft of said packages;
wherein said front plate is configured to be mounted to a front-side of said host door;
wherein said front plate includes a rigid plastic covering;
wherein said back plate is configured to be mounted to a back-side of said host door;
wherein said back plate comprises a plurality of screw apertures;
wherein said screw apertures are positioned along an outer perimeter of said back plate;
wherein said back plate further comprises a lock hole;
wherein said front plate and said back plate comprise a substantially similar profile;
wherein said front plate and said back plate comprise a rectangular-profile;
wherein said panel is rectangular shaped;
wherein said panel includes a hinged fastener;
wherein said hinged fastener is positioned on a top edge of said panel;
wherein said panel further comprises a door lock opposing said hinged fastener;
wherein said package receiving apparatus is configured to send a notification to said mobile device when said package is delivered and said locking mechanism is locked; and
wherein said opening comprises a door-chute.
